(19) United States
(12) Patent Application Publication
(10) Pub. No.: US 2025/0070291 A1
(43) Pub. Date: Feb. 27, 2025

(54) IMPURITY MANAGEMENT FOR RECYCLED CATHODE MATERIAL

(71) Applicant: Ascend Elements, Inc., Westborough, MA (US)

(72) Inventors: Eric Gratz, Westborough, MA (US); Kee-Chan Kim, Westborough, MA (US); Amir Nazari, Westborough, MA (US); Bebel Villar, Westborough, MA (US)

(21) Appl. No.: 18/237,804

(22) Filed: Aug. 24, 2023

(51) Int. Cl. H01M 10/54; C01G 53/00; H01M 4/505; H01M 4/525

(52) U.S. Cl. CPC H01M 10/54; C01G 53/003; C01G 53/44; H01M 4/505; H01M 4/525; C01P 2002/50; C01P 2006/40; C01P 2006/80; H01M 2004/028

(57) ABSTRACT

Recycling of lithium-ion batteries includes the steps of leaching a black mass including cathode and anode materials with a leaching agent, optionally including an oxidizing agent or reducing agent, to form an aqueous acidic leach solution of metal salts comprising metal salts and a plurality of impurity salts. The impurity salts are removed in various purification phases including treating with an oxygen-containing gas and optional electrodeposition and ion exchange steps, each at specified pH ranges. The amounts of the metal salts in the treated aqueous acidic leach solution are then adjusted to a desired ratio and coprecipitated to form a precursor cathode active material.

### BACKGROUND

Lithium-ion (Li-ion) batteries are a preferred chemistry for secondary (rechargeable) batteries in high discharge applications such as electrical vehicles (EVs) and power tools where electric motors are called upon for rapid acceleration. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metals such as lithium, nickel, manganese, cobalt, aluminum, iron and phosphorous, defining a so-called “battery chemistry” of the Li-ion cells.

Li-ion battery recycling seeks to recover the charge materials from exhausted or spent Li-ion battery cells (cells). Other battery materials, such as lithium and carbon (graphite), may also be recovered. Recycling typically involves physical grinding and crushing old battery packs from a recycling stream, often sourced from end-of-life EVs. The result is a granular black mass including comingled cathode material metals (such as Ni, Mn and Co) and anode materials such as graphite. Other materials, such as copper, iron and aluminum, are often present in residual quantities as impurities resulting from the grinding and shredding of the battery packs. The recycling process includes leaching the black mass to recover pure forms of the charge material metals. However, it can be difficult to eliminate all impurities.

### SUMMARY

Purification, or impurity removal from a comingled granular mass of cathode and anode materials includes air sparging of a leach solution obtained by leaching the granular mass with an acidic leach agent such as sulfuric acid. A progressive sequence of purification phases includes variations in pH for targeted impurities that enables incremental removal of the impurities. Specifically, after an initial leaching phase, each purification phase attains a successively decreasing pH until a final phase in which a ratio adjustment of cathode material metals and coprecipitation of charge material precursor in a prescribed ratio occurs. Thus, leaching of the commingled granular mass commences with a relatively low pH (typically below 1 based on a leach acid). The pH of the leach solution is increased to around 6.0 with air sparging, followed by successively lowering the pH in each phase during which a target impurity is removed. The pH is again increased following purification and a ratio adjustment of the cathode materials metals for coprecipitation of the precursor cathode active material (p-CAM).

Configurations herein are based, in part, on the observation that end-of-life lithium-ion batteries, such as from electric and hybrid vehicles (EVs), still contain substantial amounts of charge material metals in their batteries. Unfortunately, conventional approaches to recovering and recycling spent or exhausted Li-ion batteries suffer from the shortcoming that recycling tends to introduce impurities from the casing, current collectors and other materials from the complete battery pack installed in the donor vehicle. Physical dismantling, crushing and grinding of the battery back and included battery cells results in a comingled granular mass of battery materials. These impurities can have a negative effect on the resulting recycled battery sourced from the recycling stream.

Accordingly, configurations herein substantially overcome the shortcoming of impurities in a Li-ion battery recycling stream by performing a progressive purification of a leach solution of recycled battery materials for impurity removal of a host of impurity types to yield substantially pure cathode material precursor including charge material metals such as Ni, Mn, and Co for use as active cathode material in a recycled battery.

In a particular configuration, a method for producing the cathode material precursor, or p-CAM, includes leaching a black mass from a recycled lithium-ion battery stream with an aqueous acid to obtain an aqueous acidic leach solution (leach solution) of metal salts comprising a nickel salt, a cobalt salt, a manganese salt, a lithium salt, and a plurality of impurity salts. Filtering of the leach solution removes insoluble materials, and treating the filtered leach solution with an aqueous base and an oxygen-containing gas removes particular dissolved metal salt impurities as precipitates. Optionally, further purification can be provided, including electrodeposition and/or ion exchange, as specific target dissolved impurity salts are removed. Adjusting amounts of the metal salts in the treated aqueous acidic leach solution forms an adjusted leach solution according to a prescribed ratio, which is followed by coprecipitation of the metal salts from the adjusted leach solution.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a flowchart of the impurity removal progression as defined herein.

FIG. 2 shows pH ranges during the progression through the stages in FIG. 1.

FIG. 3 shows results of air sparging in the stepwise progression of FIG. 1.

FIG. 4 is a chart of impurities including zinc removed in the progression of FIG. 1.

FIG. 5 shows a graph of zinc removal as in FIGS. 1 and 3.

FIG. 6 shows a graph of nickel loss mitigation in the approach of FIGS. 1-4.

### DETAILED DESCRIPTION

Depicted below is an example method and approach for preparation of a metal sulfate solution for precursor Cathode Active Materials (p-CAM). Recycled Li-ion batteries as demonstrated herein employ cathode active materials including charge material metals such as Ni, Mn, and Co together with Li formed into a battery cell cathode or electrode in combination with a binder and conductive powder. The p-CAM is a granular mixture of recycled charge material metals prior to sintering with Li, as described in copending U.S. patent application Ser. No. 17/412,742, filed Aug. 26, 2021, entitled “CHARGE MATERIAL FOR RECYCLED LITHIUM-ION BATTERIES,” incorporated herein by reference in entirety.

In the Li-ion battery recycling process disclosed herein, a granular, comingled mixture of crushed battery materials for recycled batteries (black mass) includes both the desired charge cathode material metals, typically Ni, Mn and Co (NMC), anode materials, typically graphite, as well as other metals and materials present in the recycling stream. These other materials and metals are generally deemed impurities, and their removal improves performance of the resulting CAM when used in recycled batteries.

Retired ternary lithium-ion batteries are commonly recycled by discharging, shredding and leaching the black mass (BM) in acidic solutions. When BM is leached in acidic solutions, not only the ternary metal ions of NMC (the “desired” metals) but also other undesired metal ions are leached together. The amount and types of undesired metal ions (Al, Cu, Fe, Ca, Mg, Zn and others) in the leachates are governed by the quality of the BM and should be removed for the downstream processes and formation of recycled battery materials. One of the common methods to remove the impurity metal ions is by precipitating the impurities as metal hydroxide by adjusting leachate pH with NaOH solution. However, this approach has limitations: higher pH achieves greater impurity removal but also imposes more loss of the desired cathode active ternary metal ions. Therefore, only a subset of impurities can be removed by adjusting the pH to ≤6 in order to prevent significant loss of the cathode active metal ions. In conventional approaches, the impurity metal ions that remain (such as Cu, Ca, Mg, Zn and others) after the precipitation are often removed by conventional multi-process and multi-stage solvent extractions. These solvent extraction methods require handling of hazardous organic chemicals, involve complicated and expensive processes, and add organic impurities to the ternary metal ion solutions, which would harm the cathode active precursor synthesis if not removed before p-CAM formation. Therefore, the approach disclosed herein depicts a more efficient, simple, and cost-effective impurity management process with maximizing of the ternary cathode active metal ion recycling. It would be beneficial to provide an approach for removing undesired impurity metals without increasing the pH into a range where the desired, ternary (NMC) metals are also lost.

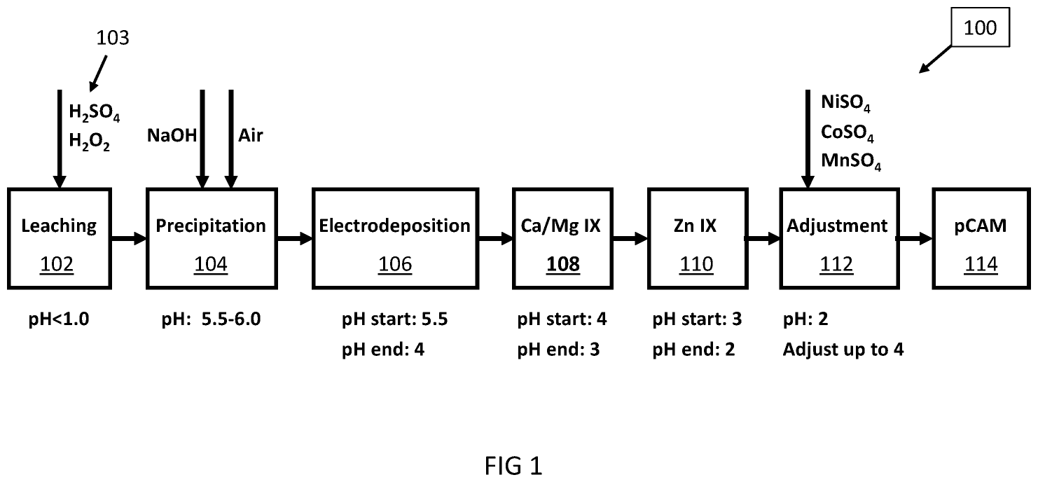

FIG. 1 is a schematic flow diagram of an impurity removal progression 100 as defined herein. Referring to FIG. 1, the method for producing a cathode material precursor (p-CAM) as defined herein includes, at step 102, leaching a black mass from a recycled lithium-ion battery stream with an aqueous acid to obtain an aqueous acidic leach solution of metal salts. The metal salts typically include a nickel salt, a cobalt salt, a manganese salt, a lithium salt, and a plurality of impurity salts. An optional reducing agent or oxidizing agent may be employed, such as hydrogen peroxide. In an example configuration, the black mass is leached in aqueous sulfuric acid at step 103, optionally with hydrogen peroxide. The oxidizing agent or reducing agent may be optional depending on whether the black mass is heat treated, such as by roasting at high temperature (such as greater than 550° C.). The leach solution therefore is an aqueous acidic solution that includes salts of the charge material metals (NMC) intended for the p-CAM to define the battery chemistry of the recycled battery, and other impurity metals.

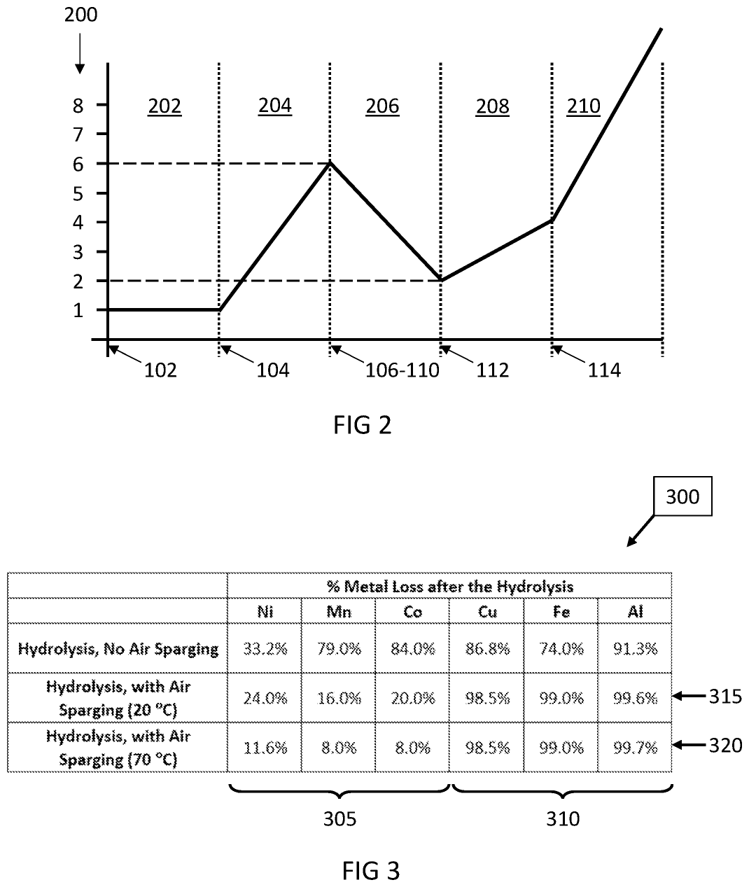

An example leach solution is formed using mass ratio of 100 g BM to 45-200 g deionized water to 70-130 g of 93%-98% H₂SO₄ to 0 g or 25-50 g of 35% H₂O₂. The BM may be thermally treated at 550° C.-700° C., and the cathode active metal ions (NMC) can be leached at 60° C.-90° C. for 2-24 hours. After leaching, the resulting leaching slurry is filtered to remove the insoluble solid matter (mostly anode active material), forming the aqueous acidic leach solution. This leachate (filtrate) generally has a pH<1.0, and the acidic pH is a direct result of the leach acid used, H₂SO₄, although other acids may be employed. At this stage, various metal ion concentrations exist in the leachate including both NMC and impurities. The pH range will undergo a series of incremental adjustments as shown in FIG. 2 below for defining the impurity removal phases/stages.

Battery recycling as described herein includes adjusting a ratio of the cathode active metal ions in the aqueous acidic leach solution according to manufacturing specifications of the new battery, and then coprecipitating the cathode metal ions in the prescribed ratio (NMC in the present example). Cathode active metal ions and cathode ions refer to the metal ions sought to fulfil the battery chemistry of the recycled battery, NMC, and generally other metals are deemed impurities. The copending application cited above details this process; the present approach strives to eliminate the impurities from the leach solution prior to coprecipitation of the cathode materials needed in substantially pure form for the p-CAM.

Accordingly, following the acidic leach, the leach solution is filtered to remove insoluble materials. The filtered leach solution is then treated with an aqueous base and an oxygen-containing gas, such as air, as depicted at step 104. In this way, some of the impurities in the leachates are removed with significant reduction in the loss of the desired metal ions as the solution pH increases to 5.5-6.0, or optionally as high as 6.5. For example, a 10-50 wt % hydroxide solution can be added to raise the pH of the filtered leach solution to form metal hydroxide precipitates with air sparging. In particular, it has been found that air sparging performs significant Cu, Al and Fe impurity removal and imposes only minor Ni, Mn and Co losses. Following the base addition and sparging, a series of one or more phases targeting specific impurities may be used, shown at steps 106, 108 and 110.

Thus, at step 104, substantial amounts of Al, Fe, Cu, Ca and Mg impurities can be removed by bubbling atmospheric air (or oxygen) at a pH to 5.5-6.0, as adjusted with sodium hydroxide. If Cu impurities are still above a desired concentration, a further reduction of Cu impurities can be achieved by electrodeposition, as depicted at step 106, particularly with an inlet pH of about 5.5 and an outlet pH of about 4. Electrodeposition involves a predetermined voltage applied to an electrode in the leach solution for adherence/deposition of copper, which can then be periodically removed from the electrode.

As a general goal, the impurity removal steps 106-110 depicted in FIG. 1 reduce amounts of the plurality of impurity salts in the treated aqueous acidic leach solution by electrodeposition, ion exchange, or both prior to adjusting the amounts of the metal salts at step 112. For example, following removal of Cu by electrodeposition at step 106, a successive phase, shown at step 108, addresses calcium and magnesium impurities in the leach solution. Fine tuning reduction of Ca and Mg impurities can be done by passing the above solution through an ion-exchange resin column with an inlet pH of about 4, resulting in an outlet pH of about 3. The resin column operates on calcium salt or a magnesium salt, such that amounts of the calcium salt or the magnesium salt are removed by ion exchange as the leach solution passes through.

Furthermore, the impurity salts often also include a zinc salt, and the amounts of the zinc salt can be reduced by ion exchange at step 110, such as through a second resin column. Optional fine tuning reduction of Zn impurities is performed by passing leach solution through an ion-exchange resin column, such that the inlet pH is about 3 and the outlet pH is about 2.

Following the stepwise progression through the impurity removal phases of steps 104-110, the now purified, aqueous leach solution is substantially free of impurity salts and rich in the cathode material active metal salts of Ni, Mn and Co (or other combination as prescribed by the battery chemistry for the recycled cells). A ratio adjustment occurs to adjust the amounts of the metal salts in the aqueous acidic leach solution as needed to form an adjusted aqueous acidic leach solution, as disclosed at step 112. Additional control or virgin metal salts are added to bring the ratio to the intended proportions for the recycled battery, described further in the copending application cited above. Common ratios include 8:1:1 of Ni:Mn:Co, so called NMC 811, and 6:2:2 for NMC 622, but any predetermined ratio may be attained.

Dissolution of the added metal salts for ratio adjustment is facilitated by the pH already being in the range of 2.0-4.0 and may be adjusted as needed. Upon completion of the ratio adjustment of the metal salts in the aqueous leach solution, the pH is increased by a strong base such as sodium hydroxide to coprecipitate the metal salts from the adjusted aqueous acidic leach solution and form p-CAM of Ni, Mn and Co in the prescribed ratio, as depicted at step 114.

FIG. 2 shows pH ranges 200 during the progression through the stages in FIG. 1. It is beneficial to note that the impurity removal occurs at acidic ranges between 1.0-6.0 and possibly lower, at which the cathode material salts remain in solution and the impurities are removed by balancing the pH with other factors at steps 104-110. At the various stages of impurity removal, impurities may be effectively removed via precipitation and filtering, may adsorb to resins and release protons, or by other suitable reaction. Referring to FIGS. 1 and 2, for a particular configuration, in a leach phase 202, the pH of the aqueous leach solution is generally less than or equal tol from addition of a strong, undiluted or modestly diluted acid such as sulfuric acid at leaching step 102. Once the metal salts are dissolved (both cathode active metal salts and impurity metal salts), and the remaining solids filtered, the pH increases during sparging phase 204 by the addition of base and an oxygen-containing gas during sparging step 104 to a pH of about 6.0, which is still low enough to maintain substantially all of the NMC metal salts in solution. During purification by impurity removal at steps 104-110, the pH incrementally decreases to about 2.0 during purification phase 206. Once impurities are removed, the pH again is increased during ratio adjustment phase 208 and co-precipitation phase 210, with the addition of base now causing the cathode material metals of NMC to precipitate out of solution.

It should be noted that the term “phase” is used to describe intervals of the overall purification process. In a typical purification process, the pH of an aqueous acidic leach solution is generally increased in order to systematically remove impurities prior to co-precipitation. However, contrary to this general process, in the present disclosure the pH of the aqueous acidic leach solution is first increased during sparging phase 204 and then decreased during purification phase 206 before increasing again during co-precipitation. As the pH follows an upward and downward progression after leaching at phase 204, significant reduction in the amounts of the of impurity salts in the treated leach solution occurs prior to adjusting the amounts of the metal salts just before phase 208.

FIG. 3 shows results of air sparging in the stepwise progression of FIG. 1. Referring to FIGS. 1-3, an oxygen-containing gas, such as air, is bubbled through the leach solution. This air sparging was found to significantly remove Cu, Al and Fe salt impurities without significant loss of Ni, Mn, or Co salts. As shown by the specific data in FIG. 3, major impurities such as Al, Fe, Cu, Ca and Mg may each be removed by bubbling air (or other oxygen-containing gas) through the leach solution and adjusting the solution pH to 5.5-6.0 with sodium hydroxide, such as a 10-50 wt % hydroxide solution with air sparging. Results 300 in FIG. 3 demonstrate that the reduction or losses of the cathode metal salts of Ni, Mn and Co 305 remain relatively low, particularly for sparging at 70° while impurity salts 310 are at least 98.5% removed by air sparging even at 20° C. (row 315), and even more so at 70° C. (row 320). In some iterations, it may be beneficial to treat the filtered aqueous acidic leach solution with the oxygen-containing gas prior to treating with the aqueous base.

While copper salt impurities can be significantly removed through sparging phase 204, the amount of these salts can be further reduced to below 1 mg/L if preferred by electrodeposition 106. Importantly, it has been found that the concentrations of the cathode active metal salts (Ni, Co and Mn salts) are not substantially different before and after electrodeposition. For example, following sparging at step 104, at step 106 electrodeposition takes the pH of the leach solution from a starting pH of from 5 to 6 prior to electrodeposition to an ending pH of from 3.5 to 4.5 after electrodeposition.

Following copper removal, ion-exchange resins can facilitate Mg and Ca removal from the leach solution. For example, once Cu impurities have been reduced to below 5 mg/L, the leach solution, which is at a pH of about 3.5-4.5 (particularly a pH=4) is passed through a column of an ion-exchange resin to remove Ca and Mg impurity. An example approach performs ion exchange via passing the treated aqueous acidic leach solution through a column comprising a dialkyl phosphonic acid impregnated resin. The Ca and Mg removed eluate, having a pH of from 2.5 to 3.5 (particularly a pH=3) at step 108 may then be fed to a successive ion-exchange resin column in step 110 to remove Zn impurity, particularly column including a bis(2-ethylhexyl)hydrogen phosphate impregnated resin, producing an eluate having a pH of from 1.5 to 2.5 (particularly a pH=2).

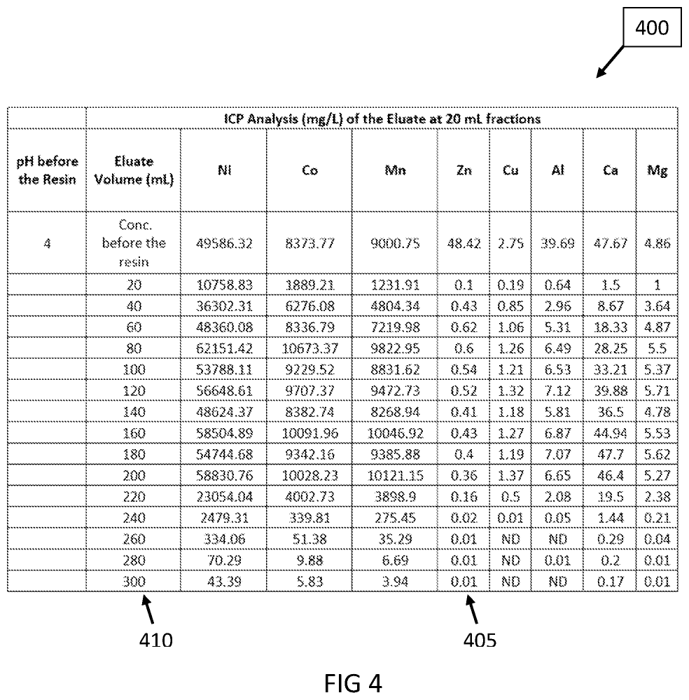

FIG. 4 is a chart of impurities including zinc removed in the progression of FIG. 1 and shows how the resin removes Zn selectively and effectively. For the resin test 400 of FIG. 4, 50 mg/L of Zn was added to a post impurity removed sample to form a synthetic solution including zinc salt impurities. The synthetic solution (200 mL) was passed through a column filled with 50 mL of resin (the resin was conditioned by a pH=4 eluent of sulfuric acid solution) with 6.6 BV flow rate. The resulting solution (pH=3) shows almost complete removal of Zn salt 405 via ion exchange based on 20 ml increments of eluate volume in column 410 and also shows significant removal of Cu and Al, as well as other impurities. Quite beneficially, the ion exchange resin columns do not substantially mitigate or reduce the concentrations of Ni, Co and Mn salts, however, and certainly demonstrate loss of less than 10% of the nickel salt, the cobalt salt, or the manganese salt.

Continuing to reference FIG. 2, the leach solution has a starting pH of from 3.5 to 4.5 prior to ion exchange (step 108) and an ending pH of from 2.5 to 3.5 after ion exchange at step 110. The treated aqueous acidic leach solution has a starting pH of from 2.5 to 3.5 prior to ion exchange and an ending pH of from 1.5 to 2.5 after ion exchange depicted at steps 108 and 110.

FIG. 5 shows a graph of zinc removal as in FIGS. 1 and 3, reiterating the results 400 of FIG. 4. Referring to FIGS. 1-5, FIG. 4 shows eluent volume 510 to zinc salt concentration 505, emphasizing substantial amounts of the zinc salt are reduced by ion exchange.

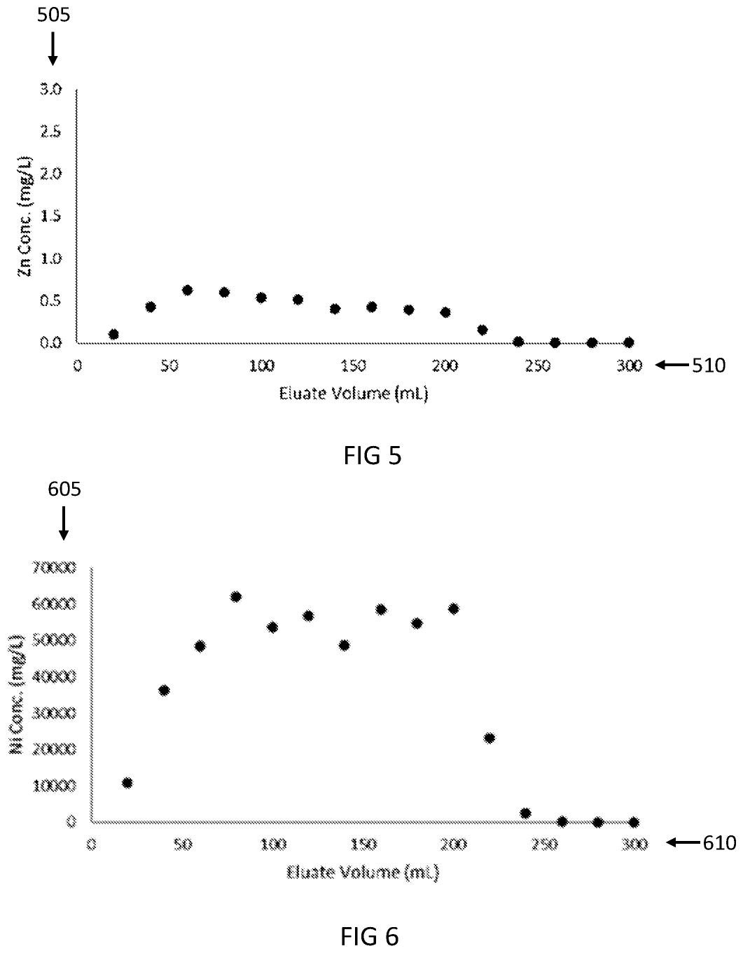

FIG. 6 shows a graph of nickel loss mitigation in the approach of FIGS. 1-4. In FIG. 6, during the ion exchange (removal) targeting zinc, a negative impact upon the highly sought nickel concentration is avoided, as nickel concentration remains relatively constant overall based on the eluate volume 610. The overall approach of the process of FIG. 1 is such that reducing the amounts of the plurality of impurity salts reduces amounts of the nickel salt, the cobalt salt, or the manganese salt by less than 10%, and NMC losses are typically much lower or even negligible.

It should be noted that following the removal of impurity salts at step 110, the treated aqueous acidic leach solution has a pH<4 (and typically about 2). It is preferable to increase the pH of the leach solution to a pH>4 prior to adjusting amounts of the metal salts at step 112.

While the system and methods defined herein have been particularly shown and described with references to embodiments thereof, it will be understood by those skilled in the art that various changes in form and details may be made therein without departing from the scope of the invention encompassed by the appended claims.

1. A method for producing a cathode material precursor comprising:
leaching a black mass from a recycled lithium-ion battery stream with a leaching agent to obtain an aqueous acidic leach solution of metal salts comprising a nickel salt, a cobalt salt, a manganese salt, a lithium salt, and a plurality of impurity salts,
filtering the aqueous acidic leach solution to remove insoluble materials,
reducing amounts of the plurality of impurity salts in the filtered aqueous acidic leach solution by electrodeposition, by ion exchange, by treating the filtered aqueous acidic leach solution with an aqueous base and an oxygen-containing gas and removing insoluble materials, or combinations thereof,
adjusting amounts of the metal salts in the impurity reduced aqueous acidic leach solution to form an adjusted aqueous acidic leach solution, and
coprecipitating the metal salts from the adjusted aqueous acidic leach solution.

2. The method of claim 1, wherein the leaching agent comprises sulfuric acid.

3. The method of claim 1, wherein the leaching agent comprises an oxidizing agent or a reducing agent.

4. The method of claim 3, wherein the oxidizing agent or the reducing agent is hydrogen peroxide.

5. The method of claim 1, wherein the black mass is heat treated prior to leaching with the aqueous acid, and wherein the leaching agent does not comprise an oxidizing agent or a reducing agent.

6. (canceled)

7. The method of claim 1, wherein the filtered aqueous acidic leach solution is treated with an aqueous base and an oxygen-containing gas and insoluble materials are removed prior to adjusting the amounts of the metal salts.

8. The method of claim 7, wherein the plurality of impurity salts comprises a copper salt, an aluminum salt, or an iron salt, and wherein treating the filtered aqueous acidic leach solution with the aqueous base and the oxygen-containing gas reduces amounts of the copper salts, the aluminum salts, or the iron salts.

9. The method of claim 7, wherein the treated aqueous acidic leach solution has a pH of from 5.5 to 6.5.

10. The method of claim 1, wherein the plurality of impurity salts comprises a copper salt and wherein amounts of the copper salt are reduced by electrodeposition.

11. The method of claim 10, wherein the filtered aqueous acidic leach solution has a starting pH of from 5 to 6 prior to electrodeposition and an ending pH of from 3.5 to 4.5 after electrodeposition.

12. The method of claim 1, wherein the plurality of impurity salts comprises a calcium salt or a magnesium salt and wherein amounts of the calcium salt or the magnesium salt are reduced by ion exchange.

13. The method of claim 12, wherein the filtered aqueous acidic leach solution has a starting pH of from 3.5 to 4.5 prior to ion exchange and an ending pH of from 2.5 to 3.5 after ion exchange.

14. The method of claim 12, wherein ion exchange comprises passing the filtered aqueous acidic leach solution through a column comprising a dialkyl phosphonic acid impregnated resin.

15. The method of claim 7, wherein the plurality of impurity salts comprises a zinc salt and wherein amounts of the zinc salt are reduced by ion exchange.

16. The method of claim 15, wherein the filtered aqueous acidic leach solution has a starting pH of from 2.5 to 3.5 prior to ion exchange and an ending pH of from 1.5 to 2.5 after ion exchange.

17. The method of claim 15, wherein ion exchange comprises passing the filtered aqueous acidic leach solution through a column comprising a [bis(2-ethylhexyl) hydrogen phosphate impregnated resin.

18. The method of claim 1, wherein reducing the amounts of the plurality of impurity salts removes less than 10% of the nickel salt, the cobalt salt, or the manganese salt.

19. The method of claim 1, wherein, after reducing the amount of the plurality of impurity salts, the impurity-reduced aqueous acidic leach solution has a pH<4, and wherein the method further comprises increasing the pH of the impurity-reduced aqueous acidic leach solution to a pH>4 prior to adjusting amounts of the metal salts.

20. A method for producing a cathode material precursor comprising:
heat treating a black mass from a recycled lithium-ion battery stream,
leaching the heat-treated black mass with a leaching agent to obtain an aqueous acidic leach solution of metal salts comprising a nickel salt, a cobalt salt, a manganese salt, a lithium salt, and a plurality of impurity salts, wherein the leaching agent does not comprise an oxidizing agent or a reducing agent,
filtering the aqueous acidic leach solution to remove insoluble materials,
treating the filtered aqueous acidic leach solution with an aqueous base and an oxygen-containing gas and removing insoluble materials,
adjusting amounts of the metal salts in the treated aqueous acidic leach solution to form an adjusted aqueous acidic leach solution, and
coprecipitating the metal salts from the adjusted aqueous acidic leach solution.

21. A method for producing a cathode material precursor comprising:
leaching a black mass from a recycled lithium-ion battery stream with a leaching agent to obtain an aqueous acidic leach solution of metal salts comprising a nickel salt, a cobalt salt, a manganese salt, a lithium salt, and a plurality of impurity salts and having a pH of <1,
filtering the aqueous acidic leach solution to remove insoluble materials,
treating the filtered aqueous acidic leach solution with an aqueous base and an oxygen-containing gas and removing insoluble materials, wherein the treated aqueous acidic leach solution has a pH>5,
reducing amounts of the plurality of impurity salts in the treated aqueous acidic leach solution by electrodeposition, ion exchange, or both, wherein the pH of the treated aqueous acidic leach solution is reduced to from 2 to 4,
increasing the pH of the treated aqueous acidic leach solution to >4 and adjusting amounts of the metal salts in the treated aqueous acidic leach solution to form an adjusted aqueous acidic leach solution, and
coprecipitating the metal salts from the adjusted aqueous acidic leach solution.
